(19) United States
(12) Patent Application Publication
(10) Pub. No.: US 2019/0006987 A1
(43) Pub. Date: Jan. 3, 2019

(54) SPLIT-TYPE POWER OPTIMIZATION WIRING BOX ASSEMBLY FOR SOLAR MODULE STRINGS OF A SOLAR PANEL

(71) Applicant: BEIJING SINBON TONGAN ELECTRONICS CO., LTD., Beijing (CN)

(72) Inventors: Zheng FANG, Beijing (CN); Jing-Jun GU, Beijing (CN); Zhi WANG, Beijing (CN); Xue-Feng ZHANG, Beijing (CN); Jian-Bin TONG, Beijing (CN)

(73) Assignee: BEIJING SINBON TONGAN ELECTRONICS CO., LTD., Beijing (CN)

(21) Appl. No.: 15/702,328

(22) Filed: Sep. 12, 2017

(30) Foreign Application Priority Data
Jul. 3, 2017 (CN) 201710532529.1

(51) Int. Cl. H02S 40/34; H02G 3/08

(52) U.S. Cl. CPC H02S 40/34; H02G 3/08

(57) ABSTRACT

A split-type power optimization wiring box assembly for solar module strings of a solar panel includes a solar panel and multiple wiring boxes mounted on the solar panel. Each wiring box has a power optimization module block mounted therein. The solar panel has multiple solar module strings with each adjacent two of the multiple solar module strings connected through a corresponding wiring box. A power output terminal of each solar module string is connected to the power optimization module block inside a corresponding wiring box, such that the multiple solar module strings can be connected in series. The power optimization module block inside each wiring box performs Maximum Power Point Tracking on the connected solar module string for fulfilling power optimization on the basis of individual solar module string, thereby reducing the power loss of the solar module strings to achieve maximum power optimization of the solar panel.

### BACKGROUND OF THE INVENTION

### 1. Field of the Invention

The present invention relates to a power optimization wiring box and, more particularly, to a split-type power optimization wiring box assembly for solar module strings of a solar panel capable of performing maximum power point tracking (MPPT) on the basis of individual solar string and providing a fail-safe bypass function.

### 2. Description of the Related Art

The power transmission efficiency of solar panels depends on solar radiation and is also involved with the electrical characteristics under load. When solar radiation on solar panels varies, the load curves for providing maximum power transmission efficiency are also changed. If the loads can be adjusted according to the load curves associated with maximum power transmission efficiency, optimized efficiency of the solar energy system can be secured. The load characteristics associated with the maximum power transmission efficiency pertain to a maximum power point. The so-called MPPT is a process that finds the maximum power point to keep the load characteristics to stay at the point and is related to a power optimization process.

Conventional solar panels with power optimization features do not occupy a large market share and those conventional solar panels in the market basically perform their power optimization based on the entire photovoltaic modules. As each solar panel typically includes three strings of photovoltaic modules, the three strings of photovoltaic modules may be subject to different solar radiations as shaded by tree leaves, buildings and the like of different forms. Under the circumstance, panel-level power efficiency optimization can be carried out while string-level power efficiency optimization may be ignored. In other words, conventional solar panels may not perform the maximum power efficiency optimization and the optimized efficacy of the solar panels from the perspective of the level of the solar strings.

As far as panel-level power efficiency optimization is concerned, the power optimization modules are integrally formed to perform power optimization of each string of photovoltaic modules on a solar panel individually. Under the circumstance, the integrally formed power optimization module is sort of bulky and may result in blockage that causes reduced power generation efficiency of the solar panel, thus preventing the solar panel from attaining its maximum power optimization and optimized efficiency.

### SUMMARY OF THE INVENTION

An objective of the present invention is to provide a split-type power optimization wiring box assembly for solar module strings of a solar panel capable of performing maximum power point tracking (MPPT) on the basis of individual solar string and providing a fail-safe bypass function.

To achieve the foregoing objective, the split-type power optimization wiring box assembly for multiple solar module strings of a solar panel includes multiple wiring boxes. Each wiring box has a housing, and a power optimization module block is mounted inside the housing. The power optimization module block has a string connection port, a power output port, a single-chip processor, and a bypass switch.

The string connection port is connected to a power output terminal of a corresponding solar module string of the solar panel.

The power output port has a positive output terminal and a negative output terminal.

The single-chip processor is connected to the string connection port and the power output port and performs maximum power point tracking (MPPT) on the corresponding solar module string.

The bypass switch is connected between the positive output terminal and the negative output terminal of the power output port.

According to the foregoing description, each wiring box is mounted on the solar panel, and the power optimization module block mounted inside the wiring box is connected to a corresponding solar module string through the wiring box to perform MPPT on the corresponding solar module string so as to achieve maximum power optimization and optimized efficacy of the solar panel. Moreover, the power optimization module block inside each wiring box has the bypass switch activated to isolate a faulty solar module string from all other solar module strings to ensure that operation of those normal solar module strings is not interrupted. Additionally, the wiring boxes are compact in size and have delicate structural design, not only causing no blockage to the solar module strings but also performing power optimization and realizing efficacy of the solar panel to the maximum degree.

Other objectives, advantages and novel features of the invention will become more apparent from the following detailed description when taken in conjunction with the accompanying drawings.

### BRIEF DESCRIPTION OF THE DRAWINGS

FIG. 1 is a schematic plane view of a split-type power optimization wiring box assembly for solar module strings of a solar panel in accordance with the present invention;

FIGS. 2A to 2D are enlarged plane views of the solar panel in FIG. 1 with the split-type power optimization wiring box assembly removed;

FIG. 3 is a schematic plane view showing multiple split-type power optimization wiring box assemblies in FIG. 1 for solar module strings of multiple solar panels and interconnection among the split-type power optimization wiring box assemblies;

FIG. 4 is a perspective view of the split-type power optimization wiring box assembly in FIG. 1;

FIG. 5 is an exploded perspective view of a wiring box of the split-type power optimization wiring box assembly in FIG. 4;

FIG. 6 is a cross-sectional view of the wiring box in FIG. 5;

FIG. 7 is an exploded perspective view of another wiring box of the split-type power optimization wiring box assembly in FIG. 4;

FIGS. 8A to 8C are divided circuit diagrams of a power optimization module block contained in one wiring box of the split-type power optimization wiring box assembly in FIG. 1; and

FIG. 9 is a functional block diagram of a single-chip processor built in the power optimization module block in FIG. 8.

### DETAILED DESCRIPTION OF THE INVENTION

The present invention primarily presents multiple solar module strings of a solar panel and a split-type power optimization wiring box assembly mounted on the solar panel. Furthermore, the split-type power optimization wiring box assembly includes multiple wiring boxes and each wiring box houses a power optimization module block therein.

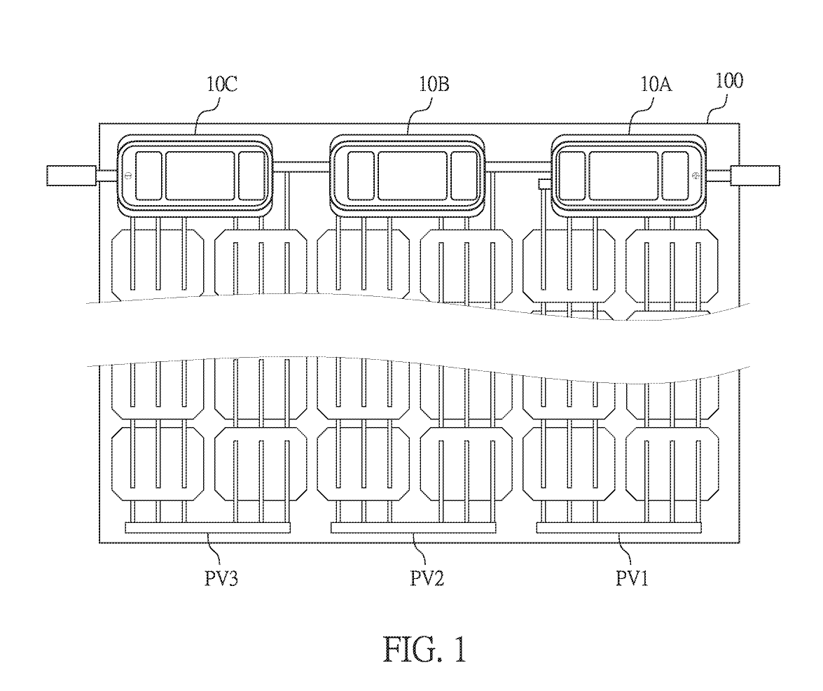

With reference to FIG. 1, the split-type power optimization wiring box assembly includes multiple wiring boxes 10A, 10B, 10C mounted on a solar panel 100. The number of the multiple wiring boxes 10A, 10B, 10C is determined according to the number of the solar module strings on the solar panel 100. In the present embodiment, as the solar panel 100 has three strings of photovoltaic modules PV1, PV2, PV3, there are three wiring boxes 10A, 10B, 10C mounted on the solar panel 100.

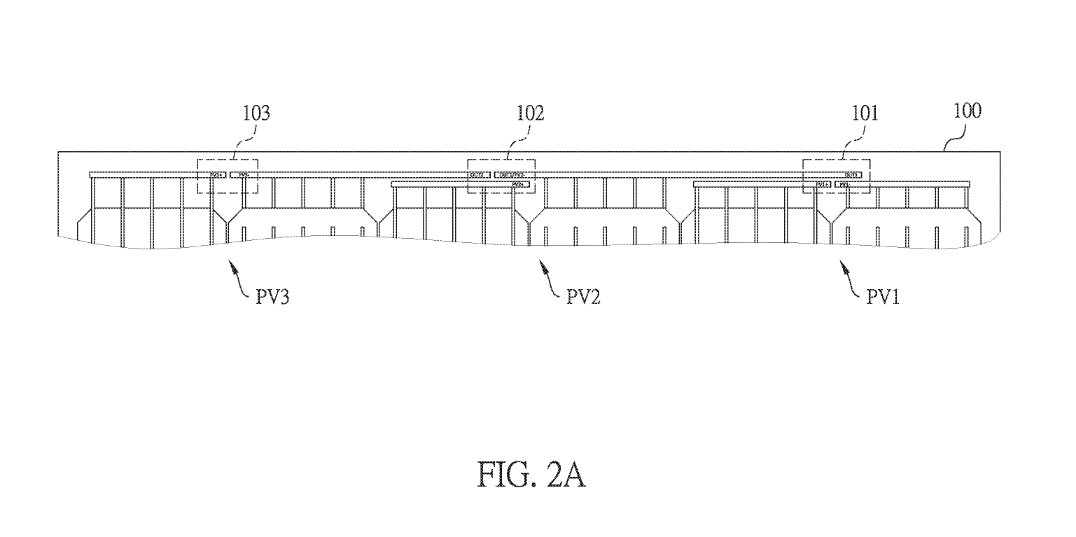

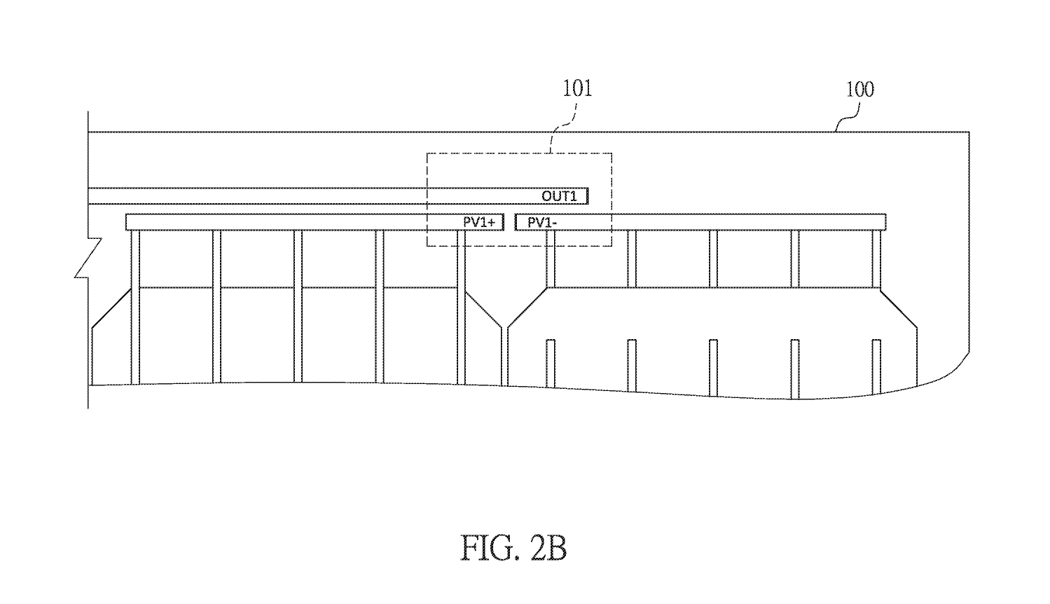

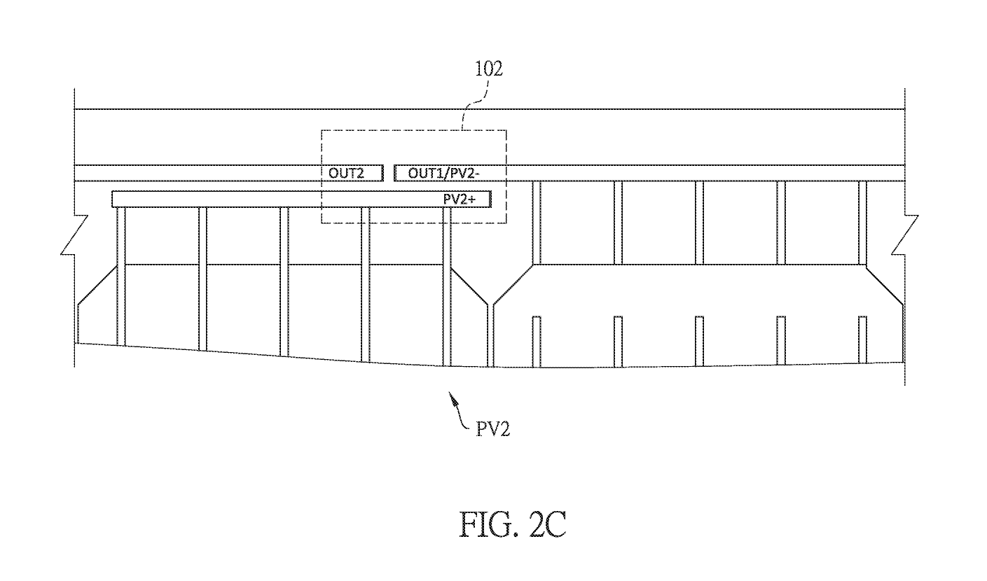

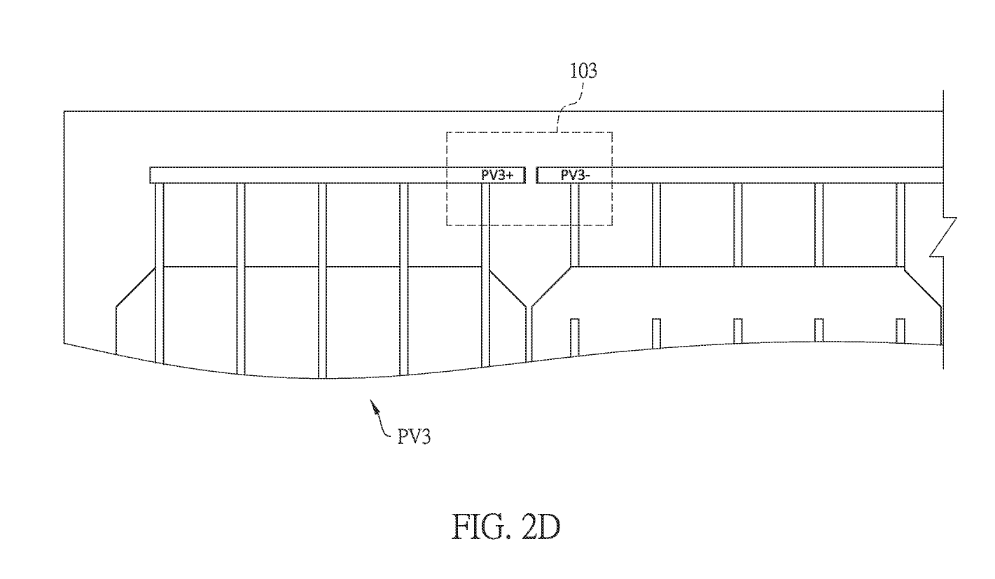

With reference to FIGS. 2A to 2D, each string of photovoltaic modules PV1, PV2, PV3 on the solar panel 100 has a power output terminal 101, 102, 103. The power output terminal 101 of the string of photovoltaic modules PV1 has a positive terminal PV1+ and a negative terminal PV1−, the power output terminal 102 of the string of photovoltaic modules PV2 has a positive terminal PV2+ and a negative terminal PV2−, and the power output terminal 103 of the string of photovoltaic modules PV3 has a positive terminal PV3+ and a negative terminal PV3−. The power output terminals 101, 102, 103 are connected in series through the wiring boxes 10A, 10B, 10C. Each wiring box 10A, 10B, 10C performs power optimization on a corresponding string of photovoltaic modules PV1, PV2, PV3.

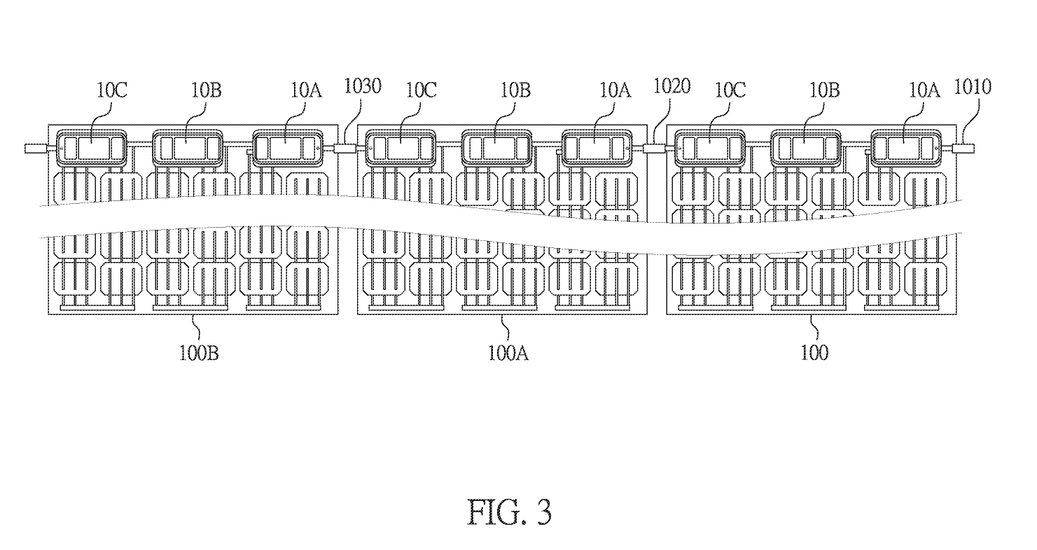

With reference to FIG. 3, besides the wiring boxes 10A, 10B, 10C being used to connect in series with the three strings of photovoltaic modules PV1, PV2, PV3, multiple electrical cables 1010, 1020, 1030 can be used to connect in series with other solar panels 100A, 100B adjacent to the solar panel 100.

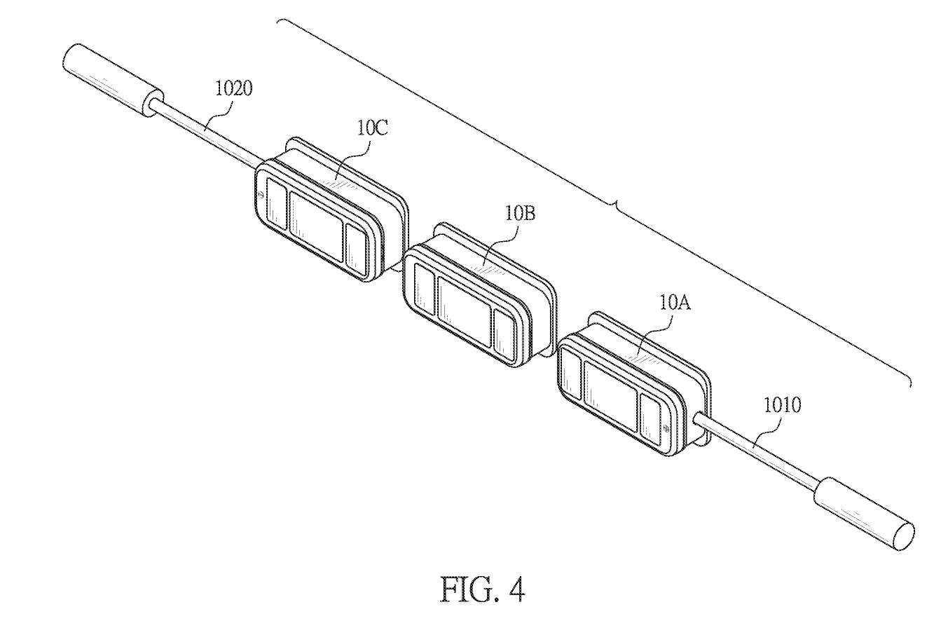

With reference to FIG. 4, the wiring boxes 10A, 10B, 10C are not directly connected with each other but are connected to the power output terminals of the strings of photovoltaic modules PV1, PV2, PV3 mounted on the solar panel 100 to indirectly constitute a serial loop. The wiring boxes 10A, 10B, 10C are structurally similar except some minute details. For example, the wiring boxes 10A, 10C adjacent to two ends of the serial loop has similar structure; however, the two wiring boxes 10A, 10C are oriented oppositely upon installation and require corresponding positioning structures based on the requirements for connecting and fixing the electrical cables 1010, 1020. Detailed description about the positioning structures is elaborated later.

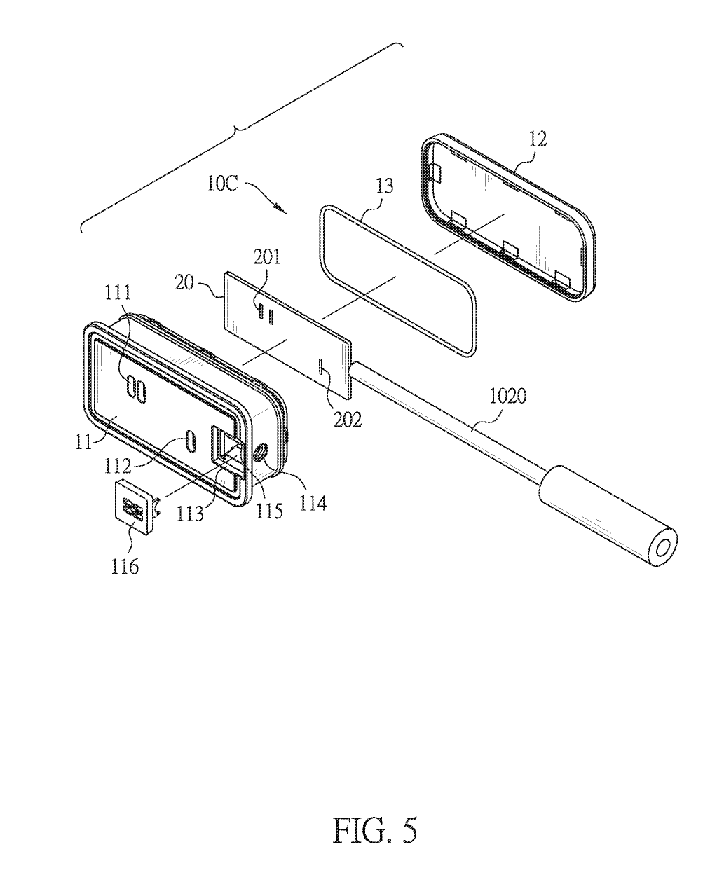

Regarding the wiring boxes 10A, 10C adjacent to two ends of the serial loop, detailed structure of the wiring box 10C located at one end of the serial loop is given as an example. With reference to FIG. 5, the wiring box 10C includes a housing 11, and the housing 11 contains a power optimization module block mounted therein. In the present embodiment, the power optimization module block is built on a circuit board 20.

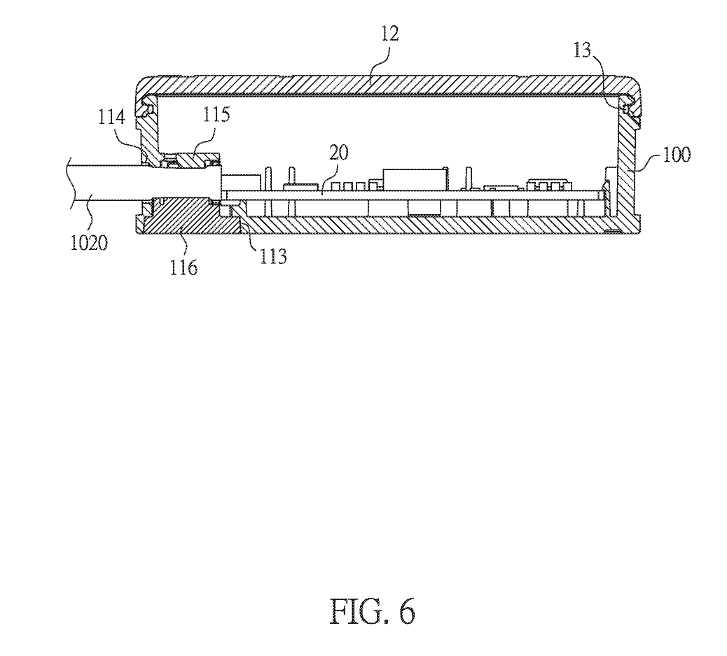

The housing 11 has a rectangular bottom and a peripheral wall formed on and protruding upwardly and vertically from a perimeter of the rectangular bottom. A space is defined between the peripheral wall and the rectangular bottom for the circuit board 20 to be accommodated therein. The housing 11 has an opening that is opposite to the rectangular bottom of the housing 11 and communicates with the space of the housing 11. To allow the power optimization module block on the circuit board 20 to electrically connect to the string of photovoltaic modules PV3 outside the housing 11, the rectangular bottom of the housing 11 has multiple through holes 111, 112 formed through the rectangular bottom, and the circuit board 20 also has multiple vias 201, 202 formed through the circuit board 20 to correspond to the respective through holes 111, 112 of the housing 11 for copper strips of an electrical connector to pass the through holes 111, 112 and the vias 201, 202 to electrically connect the circuit board 20 and the string of photovoltaic modules PV3. The housing 11 has a mounting slot 113 and a cord hole 114. The mounting slot 113 is formed through a portion of the rectangular bottom of the housing 11 adjacent to a side of the rectangular bottom. The cord hole 114 is formed through a portion of the peripheral wall adjoining the side of the rectangular bottom for the electrical cable 1020 to penetrate through and enter the space of the housing 11 for electrical connection with the circuit board 20. The portion of the peripheral wall with the cord hole 114 further has a positioning portion 115 formed on and protruding from an inner wall of the cord hole 114 in a direction parallel to the rectangular bottom of the housing 11, and facing the mounting slot 113. A positioning lid 116 is mounted on the mounting slot 113 to cover the mounting slot 113. Inner walls of the positioning lid 116 and the positioning portion 115 match a periphery of the electrical cable 1020 passing through the cord hole 114 in shape for the electrical cable 1020 to be held between the positioning lid 116 and the positioning portion 115 as shown in FIG. 6, thereby preventing the electrical cable 1020 from easily coming off the housing 11.

In the present embodiment, the housing 11 has a box cover 12 mounted on the opening of the housing 11 to cover the space inside the housing 11. To enhance weathering resistance of the wiring box 10C, a waterproof O-ring 13 mounted between the opening of the housing 11 and the box cover 12.

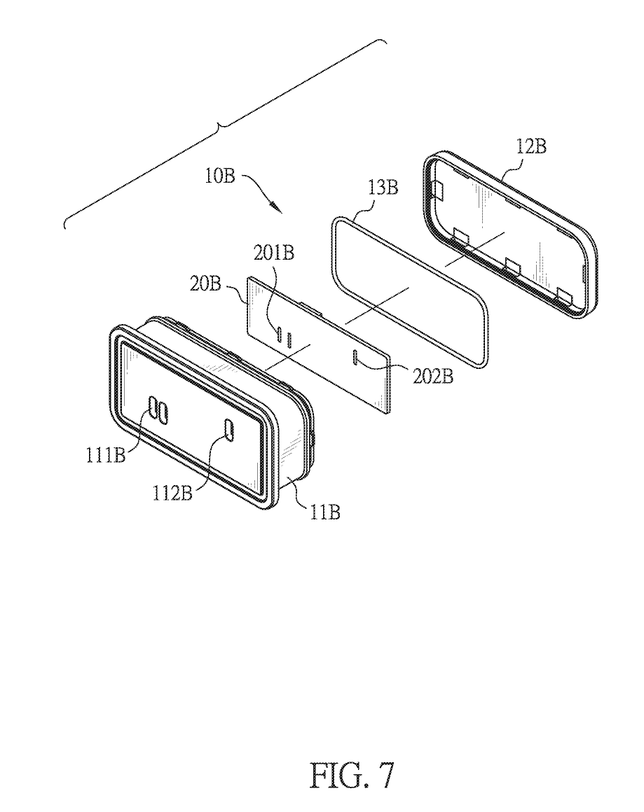

With reference to FIG. 7 for detailed structure of the wiring box 10B located between two ends of the serial loop thereof, because the wiring box 10B is located in the middle of the serial loop and there is no electrical cable connected thereto, structure required for fixing an electrical cable is therefore ignored. The wiring box 10B is structurally similar to the other two wiring boxes 10A, 10C, and has a housing 11B, a circuit board 20B with a power optimization module block mounted thereon, and a box cover 12B.

The housing 11B has a rectangular bottom and a peripheral wall formed on and protruding upwardly and vertically from a perimeter of the rectangular bottom. A space is defined between the peripheral wall and the rectangular bottom for the circuit board 20B to be accommodated therein. The housing 11B has an opening that is opposite to the rectangular bottom of the housing 11B and communicates with the space of the housing 11B. The housing 11B has a box cover 12B mounted on the opening of the housing 11 to cover the space inside the housing 11B. To enhance weathering resistance of the wiring box 10B, a waterproof O-ring 13B is mounted between the opening of the housing 11B and the box cover 12B.

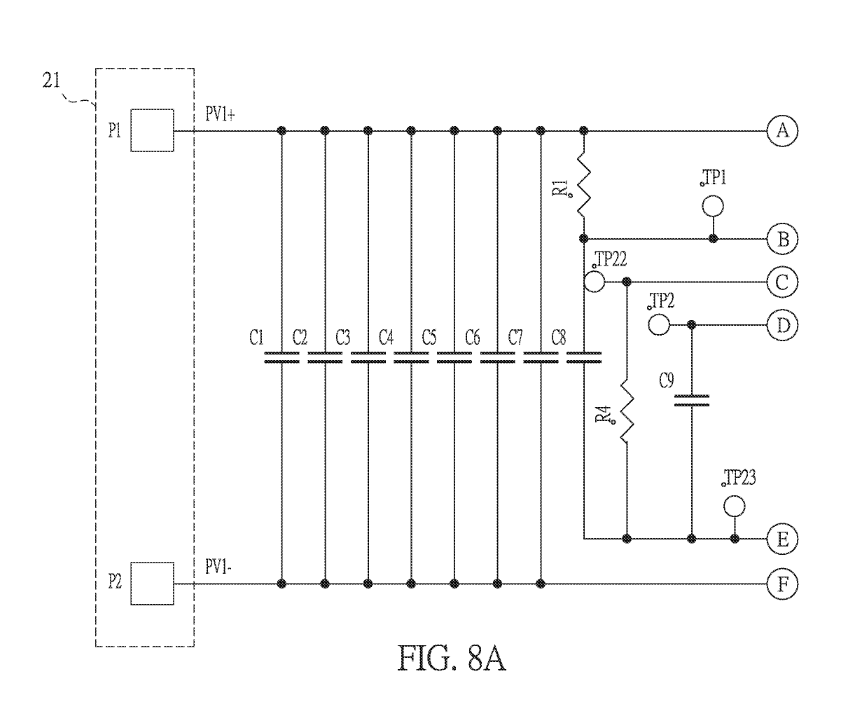

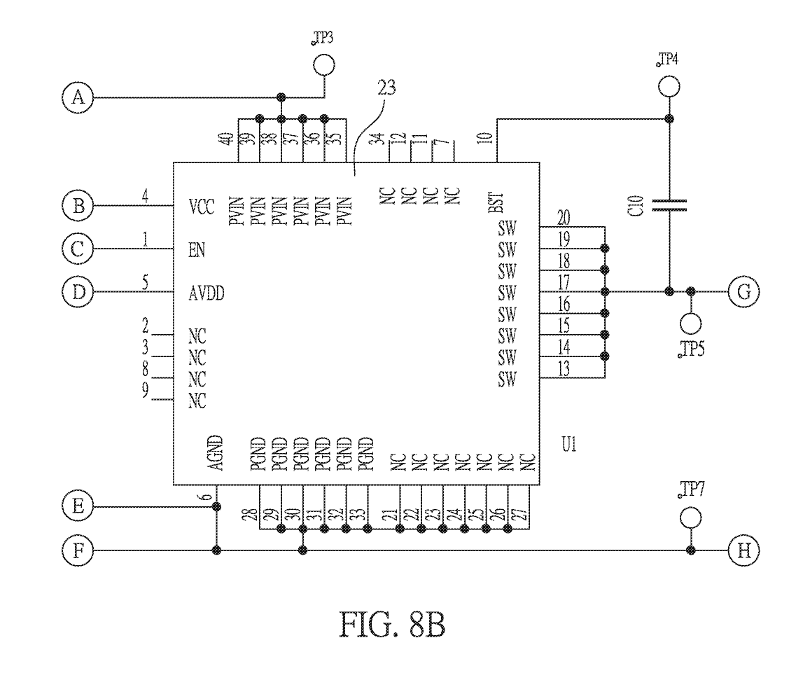

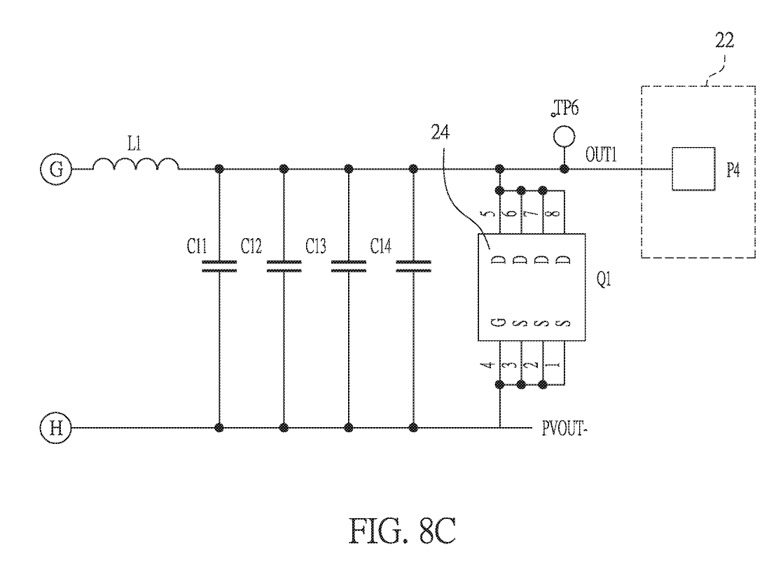

With reference to FIGS. 8A to 8C for circuit illustration of the power optimization module blocks 10A, 10B, 10C, each power optimization module block 10A, 10B, 10C includes a string connection port 21, a power output port 22, a single-chip processor 23, and a bypass switch 24.

The string connection port 21 is connected to a power output terminal of a string of photovoltaic modules on the solar panel. Given the wiring box 10A and the string of photovoltaic modules connected therewith as an example, the string connection port 21 is connected to the positive terminal PV1+ and the negative terminal PV1− of the power output terminal 101 of the string of photovoltaic modules PV1. In other words, the string connection port 21 is treated as a power input terminal to receive power transmitted from the string of photovoltaic modules PV1. Likewise, in the case of the wiring box 10B and the string of photovoltaic modules PV2 connected therewith, the string connection port 21 is connected to the positive terminal PV1+ and the negative terminal PV1− of the power output terminal 102 of the string of photovoltaic modules PV2. Furthermore, in the case of the wiring box 10C and the string of photovoltaic modules PV3 connected therewith, the string connection port 21 is connected to the positive terminal PV1+ and the negative terminal PV1− of the power output terminal 103 of the string of photovoltaic modules PV3.

The power output port 22 includes a positive output terminal and a negative output terminal for connection with the power optimization module block inside another wiring box. The bypass switch 24 is connected between the positive output terminal and the negative output terminal for isolating the connected string of photovoltaic modules from the serial loop when the string of photovoltaic modules encounters a fault.

The single-chip processor 23 is connected to the string connection port 21 and the power output port 22 and performs MPPT pertinent to the connected string of photovoltaic modules.

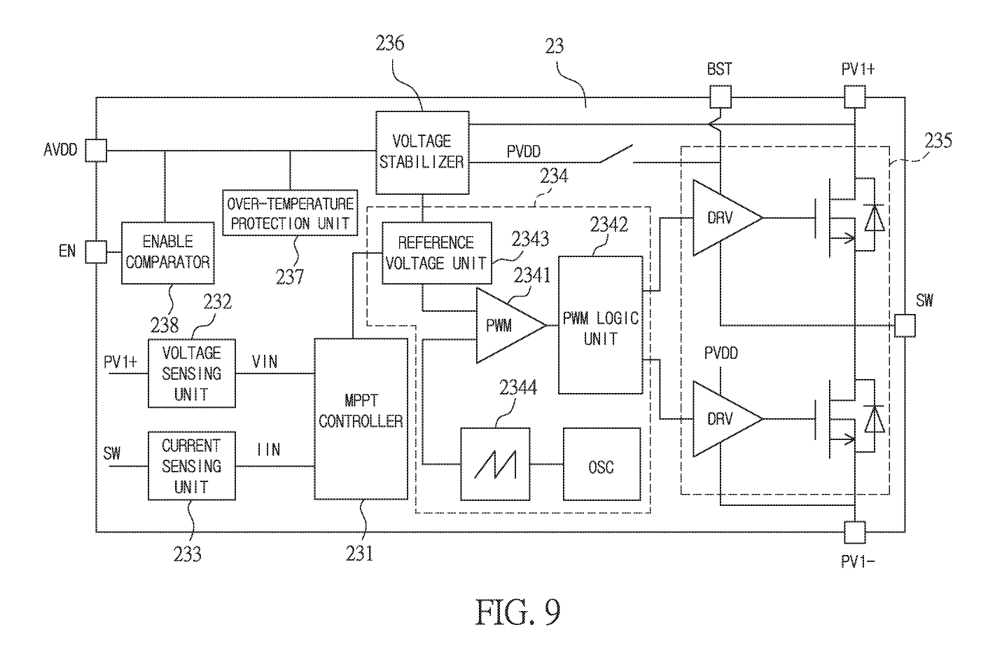

With reference to FIG. 9, the single-chip processor of each power includes an MPPT controller 231, a voltage sensing unit 232, a current sensing unit 233, a pulse width modulation (PWM) circuit 234, a buck converter 235 and a voltage stabilizer 236.

The MPPT controller 231 is connected to the voltage sensing unit 232 and the current sensing unit 233. An input terminal of the voltage sensing unit 232 is connected to the positive terminal PV1+ of the power output terminal 101, 102, 103 of a corresponding string of photovoltaic modules PV1, PV2, PV3 to detect an output voltage of the corresponding string of photovoltaic modules PV1, PV2, PV3. The current sensing unit 233 is connected to an output terminal SW of the buck converter 235 to acquire an average output current of the corresponding string of photovoltaic modules PV1, PV2, PV3. The MPPT controller 231 computes according to the output voltage and the average output current of the corresponding string of photovoltaic modules PV1, PV2, PV3 and adjusts a control signal to the buck converter 235 using the PWM circuit 234 to perform computation of MPPT on the corresponding string of photovoltaic modules PV1, PV2, PV3.

The voltage stabilizer 236 is connected to the positive terminal PV1+ of the corresponding string of photovoltaic modules PV1, PV2, PV3 through the string connection port 21 to acquire power outputted from the corresponding string of photovoltaic modules PV1, PV2, PV3 and convert the power into a stable DC (Direct Current) power as an operating power to the single-chip processor 23.

The PWM circuit 234 includes a comparator 2341, a PWM logic unit 2342, a reference voltage unit 2343, a ramp generator 2344 and an oscillator OSC. The reference voltage unit 2343 generates a reference voltage value according to a computation result for MPPT from the MPPT controller 231. The comparator 2341 compares a signal generated by the ramp generator 2344 with the reference voltage value to generate a comparison result. The PWM logic unit 2342 adjusts a control signal to the buck converter 235 according to the comparison result.

In the present embodiment, the single-chip processor 23 further includes an over-temperature protection unit 237 and an enable comparator 238. The over-temperature protection unit 237 has a temperature-sensing function. When a temperature of the single-chip processor 23 detected by the over-temperature protection unit 237 exceeds a configured value, the over-temperature protection unit 237 switches off the buck converter 235 for the single-chip processor 23 to enter a protection state.

The enable comparator 238 has two input terminals and an output terminal. The two input terminals of the enable comparator 238 are respectively connected to an enable (EN) pin and an internal voltage AVDD (5V) of the single-chip processor 23. The EN pin is used to connect with an external circuit outside the single-chip processor 23 for the external circuit to change a voltage level of the EN pin. The output terminal of the enable comparator 238 is connected to the buck converter 235.

The enable comparator 238 compares the voltage level of the EN pin with the internal voltage AVDD (5V) of the single-chip processor 23. In the case of a normal condition, the EN pin stays at a high voltage level and the enable comparator 238 is disabled. When the voltage level of the EN pin is drawn by the external circuit to a low voltage level, the enable comparator 238 switches off the buck converter 235 and bypasses the corresponding string of photovoltaic modules PV1, PV2, PV3 through the bypass switch 24 to ensure that other strings of photovoltaic modules of the solar panel 100 operate normally.

From the foregoing description, the split-type power optimization wiring box assembly for solar module strings of a solar panel can prevent over-temperature, over-voltage, under-voltage, and over-current conditions and protect each string of photovoltaic modules by means of bypassing the faulty string of photovoltaic modules, thereby reducing the performance downgrade during the life cycle of the solar panel.

The split-type power optimization wiring box assembly is mounted on a solar panel for the power optimization module block inside each wiring box to be connected to a corresponding string of photovoltaic modules and perform power optimization on the corresponding string of photovoltaic modules. When the multiple strings of photovoltaic modules on the solar panel are subject to different radiation as shaded by buildings, trees and the like, the power optimization module blocks can perform the MPPT processing based on different conditions of solar radiation to achieve maximum power optimization and optimized efficacy of the solar panel. Additionally, the split-type power optimization wiring box assembly combines functions of a solar energy wiring box and can be flexibly installed on the solar panel no matter what type of shape of element and installing position of the wiring boxes are involved in the installation.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A split-type power optimization wiring box assembly for multiple solar module strings of a solar panel, comprising multiple wiring boxes, wherein each wiring box has a housing and a power optimization module block mounted inside the housing, and the power optimization module block comprises:
a string connection port connected to a power output terminal of a corresponding solar module string of the solar panel;
a power output port having a positive output terminal and a negative output terminal;
a single-chip processor connected to the string connection port and the power output port and performing maximum power point tracking (MPPT) on the corresponding solar module string; and
a bypass switch connected between the positive output terminal and the negative output terminal of the power output port.

2. The split-type power optimization wiring box assembly as claimed in claim 1, wherein
the power optimization module block is mounted on a circuit board having multiple vias formed through the circuit board; and
the housing has:
a rectangular bottom has multiple through holes formed through the rectangular bottom to correspond to the respective vias of the circuit board;
a peripheral wall formed on and protruding upwardly and vertically from a perimeter of the rectangular bottom;
a space is defined between the peripheral wall and the rectangular bottom; and
an opening opposite to the rectangular bottom of the housing and communicating with the space.

3. The split-type power optimization wiring box assembly as claimed in claim 2, wherein the housing further has:
a mounting slot formed through a portion of the rectangular bottom of the housing adjacent to a side of the rectangular bottom;
a cord hole formed through a portion of the peripheral wall adjoining the side of the rectangular bottom for an electrical cable to penetrate through and enter the space of the housing, wherein the portion of the peripheral wall with the cord hole further has a positioning portion formed on and protruding from an inner wall of the cord hole in a direction parallel to the rectangular bottom of the housing, and facing the mounting slot; and
a positioning lid mounted on the mounting slot to cover the mounting slot, wherein inner walls of the positioning lid and the positioning portion match a periphery of the electrical cable passing through the cord hole in shape for the electrical cable to be held between the positioning lid and the positioning portion.

4. The split-type power optimization wiring box assembly as claimed in claim 2, wherein the housing further has:
a box cover mounted on the opening of the housing to cover the space inside the housing; and
a waterproof O-ring mounted between the opening of the housing and the box cover.

5. The split-type power optimization wiring box assembly as claimed in claim 1, wherein the single-chip processor includes:
an MPPT controller;
a voltage sensing unit connected to the MPPT controller and having an input terminal connected to the positive output terminal of the corresponding solar module string to detect an output voltage of the corresponding solar module string;
a buck converter having an output terminal;
a current sensing unit connected to the MPPT controller and connected to the output terminal of the buck converter to acquire an average output current of the corresponding solar module string;
a pulse width modulation (PWM) circuit; and
a voltage stabilizer;
wherein the MPPT controller performs MPPT on the corresponding solar module string according to the output voltage and the average output current of the corresponding solar module string and adjusts a control signal to the buck converter using the PWM circuit.

6. The split-type power optimization wiring box assembly as claimed in claim 2, wherein the single-chip processor includes:
an MPPT controller;
a voltage sensing unit connected to the MPPT controller and having an input terminal connected to the positive output terminal of the corresponding solar module string to detect an output voltage of the corresponding solar module string;
a buck converter having an output terminal;
a current sensing unit connected to the MPPT controller and connected to the output terminal of the buck converter to acquire an average output current of the corresponding solar module string;
a pulse width modulation (PWM) circuit; and
a voltage stabilizer;
wherein the MPPT controller performs MPPT on the corresponding solar module string according to the output voltage and the average output current of the corresponding solar module string and adjusts a control signal to the buck converter using the PWM circuit.

7. The split-type power optimization wiring box assembly as claimed in claim 3, wherein the single-chip processor includes:
an MPPT controller;
a voltage sensing unit connected to the MPPT controller and having an input terminal connected to the positive output terminal of the corresponding solar module string to detect an output voltage of the corresponding solar module string;
a buck converter having an output terminal;
a current sensing unit connected to the MPPT controller and connected to the output terminal of the buck converter to acquire an average output current of the corresponding solar module string;
a pulse width modulation (PWM) circuit; and
a voltage stabilizer;
wherein the MPPT controller performs MPPT on the corresponding solar module string according to the output voltage and the average output current of the corresponding solar module string and adjusts a control signal to the buck converter using the PWM circuit.

8. The split-type power optimization wiring box assembly as claimed in claim 4, wherein the single-chip processor includes:
an MPPT controller;
a voltage sensing unit connected to the MPPT controller and having an input terminal connected to the positive output terminal of the corresponding solar module string to detect an output voltage of the corresponding solar module string;
a buck converter having an output terminal;
a current sensing unit connected to the MPPT controller and connected to the output terminal of the buck converter to acquire an average output current of the corresponding solar module string;
a pulse width modulation (PWM) circuit; and
a voltage stabilizer;
wherein the MPPT controller performs MPPT on the corresponding solar module string according to the output voltage and the average output current of the corresponding solar module string and adjusts a control signal to the buck converter using the PWM circuit.

9. The split-type power optimization wiring box assembly as claimed in claim 5, wherein the PWM circuit includes:
a reference voltage unit generating a reference voltage value according to a computation result for MPPT from the MPPT controller;
a ramp generator;
a comparator comparing a signal generated by the ramp generator with the reference voltage value to generate a comparison result;
a PWM logic unit adjusting the control signal to the buck converter according to the comparison result; and
an oscillator.

10. The split-type power optimization wiring box assembly as claimed in claim 6, wherein the PWM circuit includes:
a reference voltage unit generating a reference voltage value according to a computation result for MPPT from the MPPT controller;
a ramp generator;
a comparator comparing a signal generated by the ramp generator with the reference voltage value to generate a comparison result;
a PWM logic unit adjusting the control signal to the buck converter according to the comparison result; and
an oscillator.

11. The split-type power optimization wiring box assembly as claimed in claim 7, wherein the PWM circuit includes:
a reference voltage unit generating a reference voltage value according to a computation result for MPPT from the MPPT controller;
a ramp generator;
a comparator comparing a signal generated by the ramp generator with the reference voltage value to generate a comparison result;
a PWM logic unit adjusting the control signal to the buck converter according to the comparison result; and
an oscillator.

12. The split-type power optimization wiring box assembly as claimed in claim 8, wherein the PWM circuit includes:
a reference voltage unit generating a reference voltage value according to a computation result for MPPT from the MPPT controller;
a ramp generator;
a comparator comparing a signal generated by the ramp generator with the reference voltage value to generate a comparison result;
a PWM logic unit adjusting the control signal to the buck converter according to the comparison result; and
an oscillator.

13. The split-type power optimization wiring box assembly as claimed in claim 5, wherein the single-chip processor further includes an over-temperature protection unit detecting a temperature of the single-chip processor, and when the detected temperature exceeds a configured value, the over-temperature protection unit switches off the buck converter for the single-chip processor to enter a protection state.

14. The split-type power optimization wiring box assembly as claimed in claim 6, wherein the single-chip processor further includes an over-temperature protection unit detecting a temperature of the single-chip processor, and when the detected temperature exceeds a configured value, the over-temperature protection unit switches off the buck converter for the single-chip processor to enter a protection state.

15. The split-type power optimization wiring box assembly as claimed in claim 7, wherein the single-chip processor further includes an over-temperature protection unit detecting a temperature of the single-chip processor, and when the detected temperature exceeds a configured value, the over-temperature protection unit switches off the buck converter for the single-chip processor to enter a protection state.

16. The split-type power optimization wiring box assembly as claimed in claim 8, wherein the single-chip processor further includes an over-temperature protection unit detecting a temperature of the single-chip processor, and when the detected temperature exceeds a configured value, the over-temperature protection unit switches off the buck converter for the single-chip processor to enter a protection state.

17. The split-type power optimization wiring box assembly as claimed in claim 5, wherein the voltage stabilizer is connected to the power output terminal of the corresponding solar module string through the string connection port to acquire power outputted from the corresponding solar module string and convert the power into a stable DC (Direct Current) operating power.

18. The split-type power optimization wiring box assembly as claimed in claim 6, wherein the voltage stabilizer is connected to the power output terminal of the corresponding solar module string through the string connection port to acquire power outputted from the corresponding solar module string and convert the power into a stable DC operating power.

19. The split-type power optimization wiring box assembly as claimed in claim 7, wherein the voltage stabilizer is connected to the power output terminal of the corresponding solar module string through the string connection port to acquire power outputted from the corresponding solar module string and convert the power into a stable DC operating power.

20. The split-type power optimization wiring box assembly as claimed in claim 8, wherein the voltage stabilizer is connected to the power output terminal of the corresponding solar module string through the string connection port to acquire power outputted from the corresponding solar module string and convert the power into a stable DC operating power.
